(19) United States
(12) Patent Application Publication
(10) Pub. No.: US 2011/0252909 A1
(43) Pub. Date: Oct. 20, 2011

(54) VARIABLE DIAMETER GEAR DEVICE WITH DIAMETER CHANGER FOR CONSTANT PITCH GEAR TOOTH SEQUENCE

(75) Inventors: Nathan Naveh, Kfar Mass (IL); Nimrod Eitan, Tel Aviv (IL); Joseph Etzion, Yehud (IL)

(73) Assignee: IQWIND LTD., Bazra (IL)

(21) Appl. No.: 12/596,984

(22) PCT Filed: Oct. 1, 2009
(86) PCT No.: PCT/IB2009/054299

§ 371 Date: Oct. 22, 2009

Related U.S. Application Data
(60) Provisional application No. 61/102,036, filed on Oct. 2, 2008.

(51) Int. Cl. F16H 55/12

(52) U.S. Cl. 74/439

(57) ABSTRACT

A variable diameter gear device for variable ratio transmission systems has a displaceable gear tooth sequence formed from interconnected gear teeth with uniform pitch lying on a virtual cylinder coaxial with an axle of the device. A torque linkage transfers a turning moment between the axle and the gear tooth sequence. A diameter changer includes at least one disc with a spiral track to which each of the gear teeth is linked. Rotation of the discs relative to the axle causes variation of an effective diameter of the virtual cylinder while the gear tooth sequences remain on a virtual cylinder centered on the axis and the uniform pitch remains constant.

### FIELD AND BACKGROUND OF THE INVENTION

The present invention relates to variable transmissions and, in particular, it concerns a variable diameter gear device with a diameter changer for changing the effective diameter of a sequence of gear teeth while the gear teeth remain at a constant pitch.

Various attempts have been made to design a gear wheel which would provide a variable diameter and variable effective number of teeth. Particularly for bicycles, many designs have been proposed in which segments of a gear wheel can be moved radially outwards so that the segments approximate to rounded corners of a toothed polygon with variable spaces therebetween. These designs can engage a chain and have a variable effective number of teeth where the spaces correspond to “missing” teeth. Examples of such designs may be found in U.S. Pat. Nos. 2,782,649 and 4,634,406, and in PCT Patent Application Publication No. WO 83/02925. This approach generates a non-circular effective gear which has missing teeth between the gear wheel segments. As a result, it is clearly incompatible with direct engagement between gearwheels. Even when used with a chain, the rotating polygonal shape may be expected to cause instability and vibration if used at significant speeds, and does not provide uniform power transfer during rotation.

A device similar to the above examples, but implemented as a toothless continuously variable transmission, is disclosed in U.S. Pat. No. 4,655,730. In this example, radial motion of segments of a ring is controlled by relative rotation of two slotted discs, one with radial slots and the other with a spiral slot.

A further variant of the aforementioned approach is presented in German Patent Application Publication No. DE 10016698 A1. In this case, sprocket teeth are provided as part of a flexible chain which is wrapped around a structure of radially displaceable segments. The chain is anchored to one of the displaceable segments and a variable excess length at the other end of the chain is spring-biased to a recoiled storage state within an inner volume of the device.

In all of the above examples, the underlying adjustment mechanisms are configured to provide purely radial motion, approximating to an expanding polygon.

Reference is made to co-pending co-assigned US Patent Application Publication No. 2009/0018043 (hereafter “the '043 application”), which was unpublished as of the filing date of the provisional application from which priority is being claimed for this application, and is not admitted prior art except where and to the extent that applicable law deems it so. The '043 application describes a variable transmission system in which sequences of gear teeth are deployed on circles of varying diameters while maintaining a constant pitch between adjacent teeth. Typically, two such sequences of gear teeth are used in combination to provide an effective cylindrical gear with a variable number of teeth. The '043 application is hereby incorporated herein by reference in its entirety. Unless otherwise stated herein, definitions of the terminology used in this document, and additional technical details of the structure of the present invention and its range of applications, are as detailed in the '043 application.

It would be advantageous to provide a variable diameter gear device with a diameter changer based on discs with spiral tracks for changing the effective diameter of a sequence of gear teeth while the gear teeth remain at a constant pitch.

### SUMMARY OF THE INVENTION

The present invention is a variable diameter gear device with a diameter changer for changing the effective diameter of a sequence of gear teeth while the gear teeth remain at a constant pitch.

According to the teachings of the present invention there is provided, a variable diameter gear device for use in a variable ratio transmission system, the variable diameter gear device comprising: (a) an axle defining an axis of rotation; (b) a displaceable gear tooth sequence comprising a plurality of interconnected gear teeth lying on a virtual cylinder coaxial with the axle, the gear teeth being spaced at a uniform pitch; (c) a torque linkage mechanically linked to the axle and to the gear tooth sequence so as to transfer a turning moment between the axle and the gear tooth sequence; and (d) a diameter changer including at least one disc having a spiral track, and wherein each of the gear teeth is mechanically linked to the spiral track such that rotation of the at least one disc relative to the axle causes variation of an effective diameter of the virtual cylinder while maintaining the virtual cylinder centered on the axis of rotation and while the uniform pitch remains constant.

According to a further feature of the present invention, the diameter changer includes a pair of the discs deployed on opposite sides of the gear tooth sequence, and wherein each of the gear teeth is mechanically linked to the spiral track of both of the pair of discs.

According to a further feature of the present invention, the spiral track is implemented as a spiral slot, and wherein a projection is associated with each of the gear teeth, the projection engaging the spiral slot.

According to a further feature of the present invention, the spiral track is shaped substantially as a logarithmic spiral.

According to a further feature of the present invention, the gear tooth sequence extends around at least half of the periphery of the effective cylindrical gear.

According to a further feature of the present invention, the displaceable gear tooth sequence is a first displaceable gear tooth sequence forming part of a gear tooth set further comprising a second displaceable gear tooth sequence having a plurality of gear teeth lying on the virtual cylinder and spaced at the uniform pitch, the diameter changer being configured to displace the gear tooth set so as to vary a degree of peripheral coextension between at least the first and the second gear tooth sequences, thereby transforming the gear device between: (a) a first state in which the gear tooth set is deployed to provide an effective cylindrical gear with a first effective number of teeth, and (b) a second state in which the gear tooth set is deployed to provide an effective cylindrical gear with a second effective number of teeth greater than the first effective number of teeth.

According to a further feature of the present invention, the diameter changer further comprises an adjustment mechanism comprising a planetary gear assembly having a first input driven by rotation of the axle, an output driving rotation of the at least one disc, and a diameter adjustment input, wherein the planetary gear assembly is configured such that, when the adjustment input is maintained static, the at least one disc is driven to rotate in constant angular alignment with the axle, and when the adjustment input is rotated, the at least one disc undergoes a corresponding rotation relative to the axle.

### BRIEF DESCRIPTION OF THE DRAWINGS

The invention is herein described, by way of example only, with reference to the accompanying drawings, wherein:

FIG. 1 is an overall view of an embodiment of a variable diameter gear device, constructed and operative according to the teachings of the present invention, including two gear tooth sequences which provide a variable diameter effective cylindrical gear engaged with an idler gear arrangement as part of a variable ratio transmission system.

FIG. 2A is an isometric view of one gear tooth sequence and an associated disc with a spiral track, forming part of a diameter changer, from the gear device of FIG. 1.

FIG. 2B is an axial view of the gear tooth sequence and disc of FIG. 2A, shown in a maximum diameter state.

FIG. 2C is a cross-sectional view taken along line A-A in FIG. 2B.

FIGS. 3A and 3B are views similar to FIGS. 2A and 2B, respectively, where the teeth not lying on the line of cross-section have been omitted for clarity.

FIGS. 4A-4E are a sequence of views similar to FIG. 2A showing a range of positions of the disc relative to the tooth sequence, ranging from an open state to a fully closed state. In each case, alongside the figure is shown a circle corresponding to the pitch circle of the effective gear wheel superimposed on a dashed-line circle corresponding to the disc outline, thereby illustrating the range of variation of the effective diameter.

FIG. 5 is a partial isometric view illustrating an adjustment mechanism for generating relative rotation between a disc of the diameter changer and the main axle of the gear device.

FIGS. 6 and 7 are schematic diagrams illustrating certain terminology which will be used in an analysis of the geometry of the present invention.

FIGS. 8A and 8B are schematic representations of two types of linkage suitable for use in implementing the variable gear device of FIG. 1; and

FIGS. 9 and 10 are schematic diagrams illustrating certain terminology which will be used in an analysis of the geometry when implementing an embodiment of the invention with the linkage of FIG. 8B.

### DESCRIPTION OF THE PREFERRED EMBODIMENTS

The present invention is a variable diameter gear device with a diameter changer for changing the effective diameter of a sequence of gear teeth while the gear teeth remain at a constant pitch.

The principles and operation of variable gear devices according to the present invention may be better understood with reference to the drawings and the accompanying description.

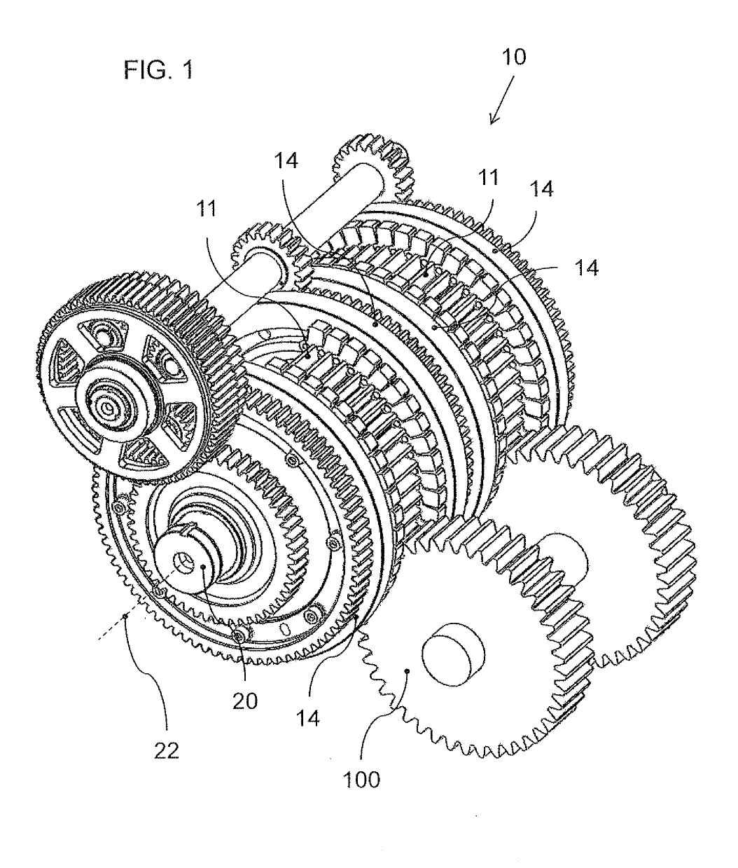

Referring now to the drawings, FIG. 1 shows an embodiment of a variable gear device, constructed and operative according to an aspect of the teachings of the present invention, generally designated 10, which is shown engaged with an idler gear arrangement 100, for use as part of a variable ratio transmission system.

Generally speaking, variable gear device 10 has an axle 20 defining an axis of rotation 22. A gear tooth set includes at least one, and in this case two, displaceable gear tooth sequences 11, each formed from a plurality of interconnected gear teeth 12 lying on a virtual cylinder coaxial with axle 20. Gear teeth 12 in each gear tooth sequence are spaced at a uniform pitch.

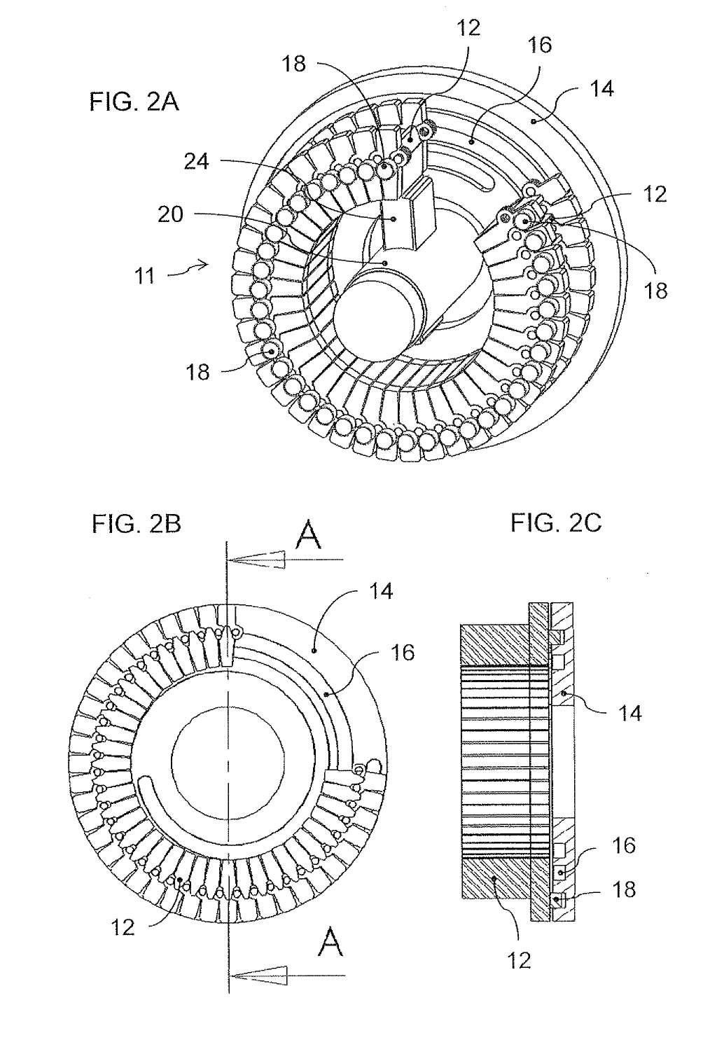

As best seen in FIG. 2A, a torque linkage is mechanically linked to axle 20 and to gear tooth sequence 11 so as to transfer a turning moment between the axle and the gear tooth set. In the preferred example illustrated here, the torque linkage is formed by a radially displaceable shaft 24, attached to or integrally formed with a given tooth 12, referred to as the “alpha” tooth. Shaft 24 passes through a corresponding slot in axle 20, typically via a linear bearing (not shown).

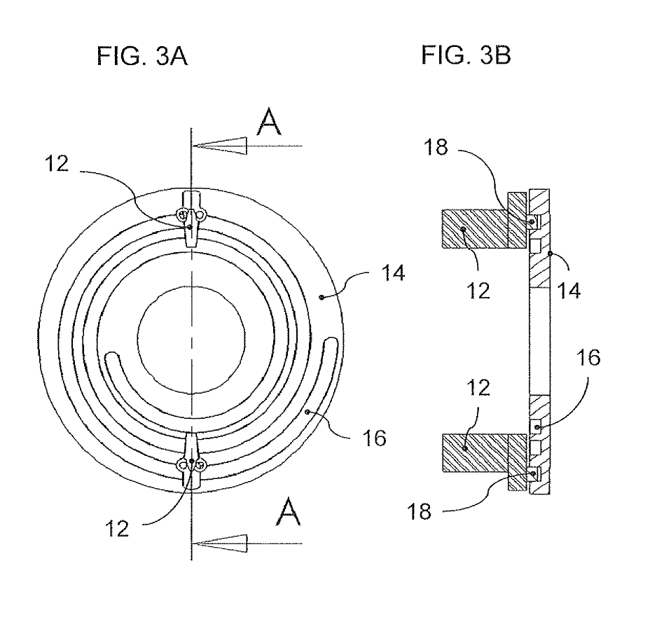

As best seen in FIGS. 2A-4E, variable gear device includes a diameter changer which includes at least one disc 14 having a spiral tack 16. Each gear tooth 12 is mechanically linked to spiral tack 16 such that rotation of disc 14 relative to axle 12 causes variation of an effective diameter of the virtual cylinder while maintaining the virtual cylinder centered on the axis of rotation and while the uniform pitch remains constant.

According to a preferred but non-limiting embodiment of the invention illustrated here, the diameter changer includes a pair of discs 14 deployed on opposite sides of each gear tooth sequence 11, and each gear tooth 12 is mechanically linked to the spiral track of both of the pair of discs. This provides stable and symmetrical support to define the radial position of each tooth. In the views of FIGS. 2A-5, the disc closer to the viewer has been removed for clarity of presentation.

According to a preferred but non-limiting embodiment of the invention illustrated here, the spiral track is implemented as a spiral slot 16, which may be a through-slot or may be fanned on only one face of disc 14. When the track is implemented as a slot, each gear tooth 12 preferably has an associated projection, such as a pin 18, which engages and slides within spiral slot 16. Each pin 18 typically has a unique offset, i.e., radial position relative to the geometrical center of the corresponding tooth 12. Thus, for example, looking at FIG. 2A, pin 18 for the alpha tooth is at the maximum radially inward offset while the tooth at the other end of the tooth sequence has the maximum radially outward offset. This corresponds to the portion of the spiral slot with which each tooth is engaged in order to maintain the gear teeth on a virtual cylinder.

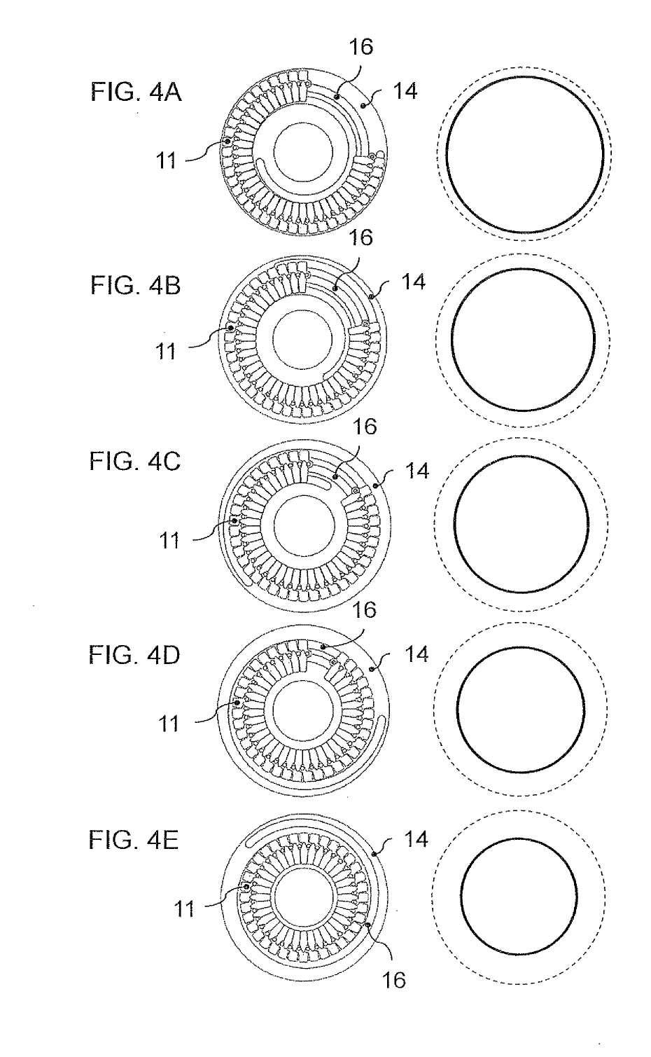

The overall effect of rotation of discs 14 relative to axle 20 is illustrated in FIGS. 4A-4E. This sequence of views shows the change in effective diameter of a single tooth sequence while the axle and the alpha tooth are kept at a constant angular position (12 o'clock) while disc 14 is rotated anticlockwise as viewed here. The corresponding change in effective diameter of the pitch centers of the teeth, corresponding to the aforementioned “virtual cylinder”, is shown as a solid circle next to each drawing. The dashed-line circle represents the outer boundary of disc 14 as a reference.

At this point, it will be helpful to define certain terminology as used herein in the description and claims. Reference is made to a “gear tooth sequence”. This refers generically to any strip, chain or other support structure which maintains the required spacing between the teeth around the periphery of the gear device in its various different states. In certain particularly preferred implementations of the gear tooth sequences of the present invention discussed below, the gear tooth sequences are formed from sequences of gear teeth which have hinge joints between them.

Reference is made to gear teeth in each gear tooth sequence having a “uniform pitch”. The “uniform pitch” here is defined functionally by the ability to mesh with a given idler gear arrangement 100 or chain across the entire range of variable diameters of gear device 10. It will be noted that a full geometrical definition of the “pitch” is non-trivial since the radius of curvature of the tooth sequences varies between states, and thus the distance between the tips of adjacent teeth typically vary as the gear device is adjusted. Furthermore, the angular pitch between adjacent teeth necessarily varies as the radial position of the tooth sequences varies. As a non-limiting exemplary geometrical definition, in some cases, it may be advantageous to maintain a constant distance between the geometrical centers (defined as the intersection of the standard pitch circle and a center line of the tooth) of adjacent gear teeth during adjustment of the gear device. In other cases, it may be preferable to maintain the distance along the pitch circle between adjacent geometrical centers substantially constant. The differentials between these definitions are typically small, and they all fall within the aforementioned broad functional definition of enabling meshing with a given idler gear over the entire range of variable diameters. Nevertheless, these options may correspond, or approximate, to different structural implementations of the linkage between adjacent teeth, and this may have an impact on the analysis and solution of the form of spiral guide track required. These distinctions will be addressed further below.

Reference is made to an “effective number of teeth” of gear device 10 in each state. The effective number of teeth in any given state is taken to be 2π divided by the angular pitch in radians between adjacent teeth about the axis of rotation. In intuitive terms, the effective number of teeth corresponds to the number of teeth that would be in a simple gear wheel which would function similarly to the current state of gear device 10. Where two or more tooth sequences are used with their gear teeth aligned in-phase with each other, the effective number of teeth is simply the number of teeth of the combined gear tooth set as projected along the axis.

Where two or more gear tooth sequences are used, reference is made to a “degree of peripheral coextension” between the gear tooth sequences. The degree of peripheral coextension corresponds to the angular extent of coextension of the gear tooth sequences around the periphery of the effective cylindrical gear, independent of the current diameter of the cylinder. When reference is made to a variable degree of peripheral coextension, this includes the possibility of the coextension being reduced to zero, i.e., where one tooth sequence provides one tooth and another provides the next tooth without any overlap therebetween. In certain particularly preferred embodiments, the maximum diameter state of each tooth sequence extends around more than half the periphery of the virtual cylinder. In this case, the peripheral coextension of the tooth sequences is preferably greater than zero.

Reference is made to an “effective cylindrical gear” to refer to a structure which is capable of providing continuous toothed engagement with a simple or compound cylindrical idler gear. The individual gear sequences of the present invention typically have spaces in them, as illustrated in FIGS. 2A and 2B. However, when used together, as illustrated in FIG. 1, they allow continuous engagement around the entire revolution of the gear device. It will be noted that the present invention may be used to advantage in transmissions based on directly engaged gear wheels and in chain-based transmissions. In all cases, it may be helpful to refer to an idler gear as a theoretical construct which may be used to define the geometrical properties of gear device 10.

An “idler gear arrangement” in this context is any gear configured for toothed engagement with gear device 10. The term “idler gear arrangement” is used to reflect a typical arrangement in which an idler gear arrangement is an intermediate component in a gear train, but without excluding the possibility of the “idler gear arrangement” being directly connected to a power input or power output axle. The idler gear arrangement is typically a compound idler gear in which two or more gear wheels are mounted so as to rotate together with a common idler axle, such as is illustrated in FIG. 1. The gear wheels making up a compound idler gear are typically identical and in-phase (i.e., with their teeth aligned), but may be implemented as out-of-phase (non-aligned teeth) gear wheels if a corresponding phase difference is implemented between the tooth sequences.

Turning now to the features of an embodiment of the invention in more details, as mentioned, the gear teeth in each gear tooth sequence are arranged so as to have a constant pitch in all states of the variable diameter gear wheel. Whatever the precise measure of pitch used, the property of maintaining constant pitch between teeth as the diameter changes necessarily results in a variable angular spacing of the teeth around the axis of the device as the diameter varies. This is clearly visible by comparing the positions of the first and last gear teeth in FIGS. 4A and 4E. As a result, a simple Archimedean spiral (radius increasing as a linear function of angle) cannot provide a true circular geometry throughout the range of diameters. A closer approximation is provided by a logarithmic spiral, which has the property of a constant increase in radius for a given length along the spiral. This too is not a theoretically perfect solution, since it is the pitch which is constant rather than the distance between pins of the offset brackets along the spiral slot. Nevertheless, particularly for a relatively shallow-angle spiral, a path corresponding to, or approximating to, a logarithmic spiral may be found, either by analytical numerical methods or empirically by trial and error, to maintain the circular profile of the gear teeth at each diameter to within an acceptable range of tolerances throughout the range of diameters covered by the device.

By way of non-limiting examples, the Theoretical Analysis section below sets out a theoretical analysis and a practical example of a solution for the shape of the spiral slot and the corresponding pin offsets. The particular values mentioned as an example in the example may be regarded as indicative of a particularly preferred example, but are also non-limiting with regard to the general scope of the present invention.

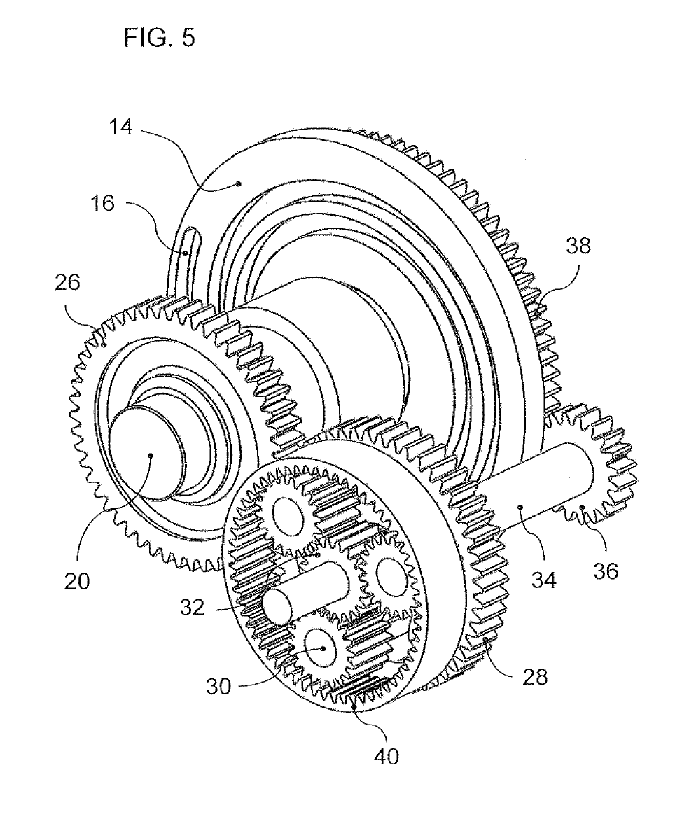

It will be appreciated that, during normal driving engagement with variable diameter gear 10 while no transmission ratio shift is being implemented, tooth sequences 11 and discs 14 rotate at the same speed. When a shift in transmission ratio is required, a predefined angular motion between discs 14 and tooth sequences 11 is performed. Various mechanisms may be used to ensure that the discs and tooth sequences normally turn together and can made to undergo relative rotation as required. One non-limiting example is illustrated herein with reference to FIG. 5.

Thus, according to an embodiment of the invention, the diameter changer has an adjustment mechanism in which a planetary gear assembly has a first input driven, directly or indirectly, by rotation of axle 20, an output directly or indirectly driving rotation of discs 14, and a diameter adjustment input. The planetary gear assembly is configured such that, when the adjustment input is maintained static, disc 14 is driven to rotate in constant angular alignment with axle 20, and when the adjustment input is rotated, disc 14 undergoes a corresponding rotation relative to axle 20.

Specifically, the non-limiting preferred example of FIG. 5 illustrates a gear wheel 26, which is fixed to rotate together with axle 20 (and hence also with the gear tooth sequences 11 which are omitted here for clarity). Gear 26 engages a gear 28 which turns the “planets” yoke of a planetary gear arrangement 30. The “sun” 32 of the planetary gear arrangement is fixed to an axle 34 which also rotates gear wheels 36 which engage a gear wheel 38 integrated with the discs 14. An actuator, such as a motor (not shown), is deployed for selectively driving an outer ring 40 of the planetary gear arrangement in order to effect the diameter change. The ratios of all of the gear wheels in this sequence are chosen such that, when outer ring 40 of the planetary gear arrangement is kept still, gears 26 and 38 turn at the same angular rate, thereby keeping gear tooth sequences 11 and discs 14 in constant angular relation as they rotate. Rotation of outer ring 40 of the planetary arrangement causes angular displacement between gear tooth sequence 11 and disc 14, thereby achieving diameter adjustment.

The embodiment of the adjustment mechanism described here is believed to provide various advantages, including allowing control of ratio shifting by operation of a single motor, and by avoiding structural complexity of the central axle of the device. Nevertheless, it should be noted that alternative implementations of an adjustment mechanism for controlling rotation of discs 14 relative to axle 20, for example, employing an on-axis mechanism for varying alignment of coaxial hollow shafts, also fall within the scope of the invention.

Referring again briefly to FIG. 1, as mentioned above, an embodiment of variable gear device 10 employs a gear tooth set including two similar displaceable gear tooth sequences 11 which are displaced by the diameter changer so as to vary a degree of peripheral coextension between at least the first and the second gear tooth sequences. Gear device 10 is thereby transformed between a first state in which the gear tooth set is deployed to provide an effective cylindrical gear with a first effective number of teeth, and a second state in which the gear tooth set is deployed to provide an effective cylindrical gear with a second effective number of teeth greater than the first effective number of teeth.

### Theoretical Analysis

### Presentation of the Problem

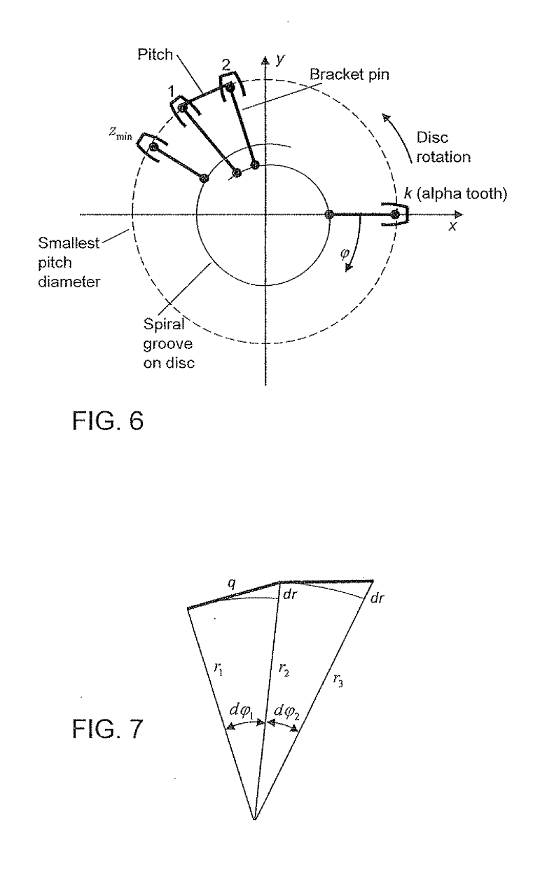

Referring now to FIGS. 6-10, a theoretical analysis and practical example of a solution for the shape of a spiral slot and corresponding pin offsets for various cases will be addressed. It should be noted that this analysis is provided to facilitate understanding, but should not be considered to limit the scope of the present invention, which may be implemented in numerous alternative ways. Specifically, the approximation of the spiral as a logarithmic spiral, with or without further adjustments by calculation or by trial and error, is fully sufficient to allow implementation of the present invention as claimed, independent of the accuracy or otherwise of the theoretical analysis herein. The particular values mentioned as an example below may be regarded as indicative of a particularly preferred example, but are also non-limiting with regard to the general scope of the present invention.

The geometric analysis relates to a situation as described in which, by employing a rotating spiral groove, a gear can change its outer diameter between two given limits. In the process of diameter increase, the teeth are pushed out, keeping their outer ends on a common circle. In the increased circumference, additional effective teeth are introduced (for example, by overlap of two sequences), keeping the gear complete at all times.

In the process of diameter increase, the number of effective teeth changes from some zₘᵢₙ to zₘₐₓ. During this process, all teeth move outward in their radial direction, but only one tooth, named the “alpha tooth,” remains in a constant angular direction, while all other teeth change their angular orientation in addition to their radial displacement. A schematic description of the rotation mechanism is shown in FIG. 6.

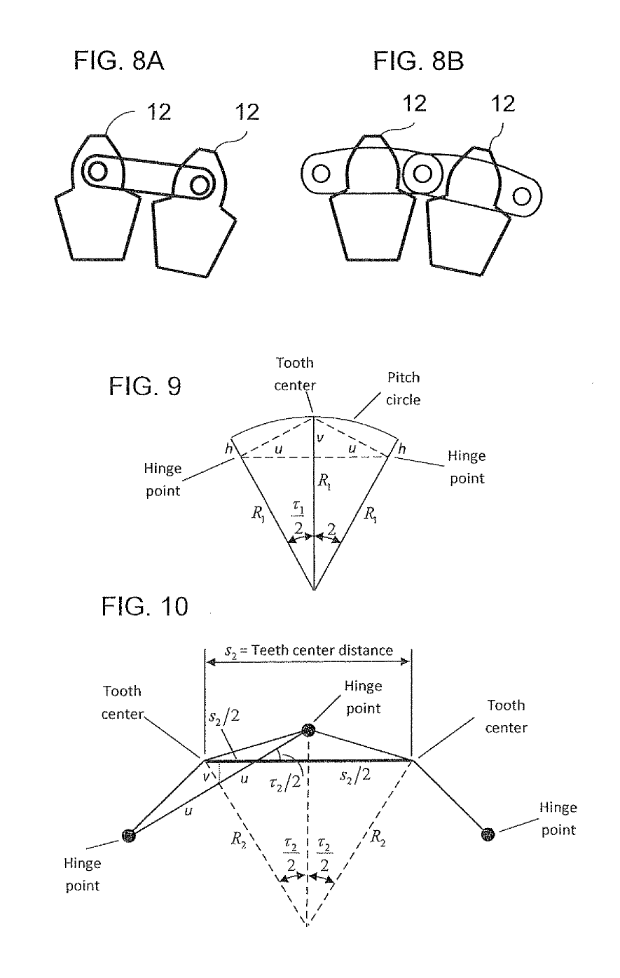

In FIG. 6, the gear wheel is shown in its closed state, with teeth numbered from 1 to zₘᵢₙ, while the alpha tooth gets the number k. All teeth are attached to a spiral groove, etched in the rotating disc. The attachments are done via pins, with an offset length appropriate for each individual tooth. From the closed state (as shown in FIG. 6) the disc rotates counter-clockwise (CCW), while all teeth attachments slide in the groove in the clockwise (CW) direction—relative to the disc. During the disc rotation, the alpha tooth is kept in a fixed (x) direction, moving outward radially, according to the local slope of the spiral. At the same time all the other teeth also slide along the spiral, while increasing their pitch diameter. Since the teeth are linked to one another by a rigid link (see FIGS. 8A and 8B below), they are forced to decrease their angular pitch in accordance with the diameter increase. As a result, all teeth become closer to the alpha tooth in their angular position, which means that an angular gap is being created between tooth 1 and tooth zₘᵢₙ. This gap is assumed to be filled by additional effective teeth (e.g., from another gear tooth sequence not shown here), so that the total number of effective teeth increases to zₘₐₓ.

The angular position of the teeth along the spiral is measured by the angle φ, such that in a closed gear (with minimum number of teeth) the alpha tooth is at angle φ=0. When the disc with the spiral groove is rotated CCW by a certain angle φ, the angular value of the alpha tooth increases by exactly the same amount φ, but the increase is in the CW direction relative to the disc (see FIG. 6). At the same time, because of the changing angular distance between adjacent teeth, all teeth except the alpha tooth change their angular position on the spiral by an angle slightly different from φ. For all teeth between l and k the angular change along the spiral becomes slightly greater than φ, while for all teeth above k the change is slightly less than φ. This variation of angular displacement is used for devising an approximate analytic solution of the spiral function, as shown below.

### Approximate Analytic Solution

The analytic solution given in this section derives a differential equation of the spiral radius, which depends on the spiral angle φ (FIG. 6). For the definition of the differential equation we reduce the pitch length, p, to an infinitesimally small magnitude. A projection of p on the spiral, which will be called here the “spiral pitch,” is approximately proportional to p. The spiral pitch will be named q. FIG. 7 shows two such infinitesimal spiral-pitch lengths on the assumed spiral curve.

If we imagine that the disc with its spiral groove is rotated CCW by a small angle, such that the tooth positioned at r₁ moves to r₂, while the tooth at r₂ moves to r₃. The radius of the spiral grows from one step to the next (r₂>r₁), while the spiral pitch, q, is assumed constant, which means that the consecutive angular steps must decrease. At the same time, in order to keep the pitch radius of the teeth unique, the radial increment, dr, must be kept constant.

The derivative of the spiral radius at position r₁ is dr/dφ₁. According to the explanation given in the preceding paragraph, the derivative at position r₂ must be modified to

$$\frac{d r}{d {ϕ}_{2}} = \frac{d r}{d {ϕ}_{1}} \frac{{r}_{2}}{{r}_{1}} = \frac{d r}{d {ϕ}_{1}} \frac{{r}_{1} + d r}{{r}_{1}} . \qquad ( 2.1 )$$

The second derivative of the spiral radius is by definition given by

$$\frac{{d}^{2} r}{d {ϕ}^{2}} = \frac{d r / d {ϕ}_{2} - d r / d {ϕ}_{1}}{d ϕ} , \qquad ( 2.2 )$$

where dφ is an “average” angular step.

A substitution of Equation 2.1 in Equation 2.2 gives the following differential equation of the spiral radius:

$$\frac{{d}^{2} r}{d {ϕ}^{2}} = \frac{1}{r} {( \frac{d r}{d ϕ} )}^{2} . \qquad ( 2.3 )$$

The solution of Equation 23 is given by the following simple exponential function:

r(φ)=r₀e^{bφ}, (2.4)

where r₀ and b are parameters to be determined by additional conditions of the spiral. Here r₀ is the (yet unknown) spiral radius at φ=0 (which is the position of the alpha tooth on the spiral in a closed gear), and b is the slope of the spiral. An optimal solution of these parameters is derived by an iterative calculation of curve fitting, shown in Chapter 5. For starting the iterations we need some initial values of the two parameters. For such initialization we assume that the spiral is rotated from φ=0 to some maximum turn angle, φ=100 ₘₐₓ, while the pitch radius grows from Rₘᵢₙ to Rₘₐₓ. For the initialization we only need very approximate parameter values, for which it can be assumed that the spiral radius (at the alpha tooth) is equal at all times to the current pitch radius, which means that r(0)=Rₘᵢₙ and r(φₘₐₓ)=Rₘₐₓ. These two conditions result in the following initial parameter values:

$$\begin{matrix}{r}_{0} = {R}_{min} , & ( 2.5 ) \\ b = \frac{1}{{ϕ}_{max}} ln \frac{{R}_{max}}{{R}_{min}} . & ( 2.6 )\end{matrix}$$

### Side Hinge Links

FIGS. 8A and 8B illustrate two non-limiting geometrical arrangements for interlinking of adjacent teeth of the tooth sequences. In the option of FIG. 8A, each tooth corresponds to a pivot axis in the linkage. This arrangement typically maintains a substantially constant linear pitch between adjacent gear teeth.

An alternative linkage, referred to as a “side hinge link” or a “tooth centered link”, is shown in FIG. 8B. This linkage may be preferred in certain cases, since it provides a better approximation to a constant pitch between teeth as measured along the pitch circle.

In a center hinge link such as in FIG. 8A, the chord, which is the linear distance between adjacent teeth, is constant, which means that in a variable-diameter gear the circular pitch varies as a result of the diameter change: the greater the diameter, the smaller becomes the circular pitch. In a side hinge link, in contrast, as a result of the diameter increase there is a slight increase of the linear distance between adjacent teeth, which to a large extent compensates for the circular-pitch variation which occurs in the center hinge geometry.

The exact geometry of a side-hinge link is determined for a gear wheel with a given number of teeth, z₁, and a given module, giving a certain pitch radius, R₁. The characteristic geometric parameters of a side-hinge link are shown in FIG. 9.

In this basic geometry, all the tooth centers and the hinging points are located on the same pitch circle of radius R₁. The hinging points are located at exactly a half-way between the angular teeth locations. The pitch angle, τ₁, is in this case given by

τ₁=2π/z₁. (3.1)

For the later calculations of variable diameter we shall need the values of the parameters u and v, shown in FIG. 9. These parameters are given by

$$u = ( {R}_{1} - h ) sin \frac{{τ}_{1}}{2} , v = {R}_{1} - ( {R}_{1} - h ) cos \frac{{τ}_{1}}{2} , \qquad ( 3.2 )$$

where h is a given displacement of the hinge point from the pitch circle.

The pitch radius, R₁, is given by

R₁=mz₁/2, (3.3)

where in is the module.

Suppose now that the number of teeth in the gear has been changed to z₂, with a new pitch radius R₂. In the new gear, the linear distance between adjacent teeth is determined by the geometry shown in FIG. 10.

In the new gear, the pitch angle is given by

τ₂=2π/z₂. (3.4)

And, according to the geometry in FIG. 5, the linear distance between tooth centers is

$${s}_{2} = 2 ( u cos \frac{{τ}_{2}}{2} + v sin \frac{{τ}_{2}}{2} ) , \qquad ( 3.5 )$$

where u and v are given by Equations 3.2.

It can be verified that in the original gear, with number of teeth equal to z₁, Equation 3.4 reduces to s₁=2u, as it should be (compare with FIG. 9). This result is obtained by substituting τ₁ instead of τ₂ in Equation 3.5, in addition to the substitution of the explicit expressions of u and v from Equations 3.2.

According to FIG. 5, the pitch radius in the modified gear, R₂, is given by

$${R}_{2} = \frac{{s}_{2}}{2 sin ( {τ}_{2} / 2 )} , \qquad ( 3.6 )$$

and the circular pitch of the two gears is given by

$$\begin{matrix}{p}_{1} = {R}_{1} {τ}_{1} \\ and & ( 3.7 ) \\ {p}_{2} = {R}_{2} {τ}_{2} = \frac{{s}_{2} {τ}_{2}}{2 sin ( {τ}_{2} / 2 )} . & ( 3.8 )\end{matrix}$$

### Optimal Displacement Determination

An “optimal” value of the hinge displacement, h (FIG. 9), by our definition, is such which equates the circular pitches of the two gear sizes, z₁ and z₂. The equality requirement states that

p₁=p₂, (4.1)

where p₁ and p₂ are the corresponding circular pitches in gears with z₁ and z₂ teeth, respectively.

By using the explicit Equations 3.7 and 3.8 for the two circular pitches, Equation 4.1 becomes

$${R}_{1} {τ}_{1} = \frac{{s}_{2} {τ}_{2}}{2 sin ( {τ}_{2} / 2 )} , \qquad ( 4.2 )$$

where s₂ is given by Equation 3.5.

Notice that s₂ depends on the displacement, h, via u and v, which are functions of h, as given by Equations 3.2. Hence, by substituting Equations 3.2 in Equation 3.5, and then substituting the resulting expression of s₂ in Equation 4.2, we get a single equation which is linearly dependent on h. This linear equation provides the following solution of the necessary displacement:

$$h = ( 1 - \frac{( \frac{{τ}_{1}}{{τ}_{2}} - 1 ) sin \frac{{τ}_{2}}{2}}{sin \frac{{τ}_{1} - {τ}_{2}}{2}} ) {R}_{1} , \qquad ( 4.3 )$$

where R₁ is the pitch radius of the first gear (Equation 3.3), and τ₁ and τ₂ are the pitch angles of the two gears (Equations 3.1 and 3.4).

Since τ₁ and τ₂ are very small angles, the sines in Equation 4.3 can be expanded into a power series, retaining only the first two terms of the series and ignoring the rest. As a result of such expansion, Equation 4.3 is reduced to the following simple approximation:

$$h = \frac{{R}_{1} {τ}_{1}}{24} ( 2 {τ}_{2} - {τ}_{1} ) . \qquad ( 4.4 )$$

Equation 4.4 provides results practically identical to those of Equation 4.3.

Obviously, the displacement, h, can be determined by equating the circular pitches of any two selected gear sizes, z₁ and z₂. For other gear sizes, different from either z₁ or z₂, the resulting circular pitch (for the given h) will differ slightly from the original circular pitch, p₁. For a given number of teeth, z₁, the resulting circular pitch, p₁, can be calculated by an equation similar to Equation 3.8:

$${p}_{i} = \frac{{s}_{i} {τ}_{i}}{2 sin ( {τ}_{2} / 2 )} , \qquad ( 4.5 )$$

where τ₁ is the pitch angle and sᵢ is the corresponding distance between the tooth centers, both calculated by equations similar to Equations 3.4 and 3.5.

As said before, there will be a slight difference between the resulting circular pitch, pᵢ, and the original pitch, pᵢ. This difference is given by

Δpᵢ₌ₚᵢ−p₁. (4.6)

As a numeric example for demonstrating the effect of the hinge-point displacement, the following parameters were used:

m=5 mm Module

z₁=36 Number of teeth in basic gear

z₂=48 Number of teeth in increased gear

Without displacement, i.e., when h=0, the circular pitches of the two gears become:

p₁=15.7080 mm, p₂→15.7105 mm,

which show a difference of 2.5 μ.

In order to reduce the magnitude of p₂ exactly to the length of p₁, the “h” displacement, calculated by Equation 4.3 or 4.4, becomes

h=57.1 μ.

With such hinge displacement, p₂ becomes exactly equal to p₁, but at the other intermediate gear sizes, small deviations from p₁ still remain. These deviations, calculated by Equation 4.6, correspond to a maximum pitch difference of only about 0.6 micron.

### Optimal Solution

By rotating the disc from its initial orientation (φ=0) to final orientation (φ=φₘₐₓ) the pitch radius of the gear increases from a given Rₘᵢₙ (closed gear) to some Rₘₐₓ (open gear), while the number of teeth increases from a given zₘᵢₙ to a given zₘₐₓ. In one of these limits, say at the closed state, the pitch radius can be obtained exactly, such that all teeth can be positioned at the same identical Rₘᵢₙ. This condition is achieved by choosing the appropriate exact bracket offsets which connect all teeth to the computed spiral in the closed state of the gear. However, by rotating the disc to the other limit, with the number of teeth increased to zₘₐₓ, all teeth will not exactly match at a common pitch radius, but each tooth will deviate to a certain extent from some average pitch radius. The goal of the optimal solution, given in this chapter, is to find the best set of parameters r₀ and b (Equation 2.4) which will minimize, as much as possible, the radial differences of the individual teeth in all stages of the disc rotation.

The required data for the spiral design include the following input parameters:

m—module

zₘᵢₙ—minimum number of teeth

zₘₐₓ—maximum number of teeth

k—sequential number of the alpha tooth

φₘₐₓ—maximum turning angle

All the rest is calculated as will now be explained.

Rₘᵢₙ=mz^{min}/2 Minimum pitch radius (5.1)

τ₁=360/zₘᵢₙ Pitch angle in closed gear (5.2)

τ₂=360/zₘₐₓ Pitch angle in open gear (5.3)

We assume at present that the side-hinge link is determined by the minimum number of teeth, zₘᵢₙ, which means that for the calculation of the u and v parameters, zₘᵢₙ and Rₘᵢₙ have to be substituted for z₁ and R₁, respectively. In that case, the linear pitch distance, s₂, and the maximum pitch radius, Rₘₐₓ, are calculated by Equations 3.4 and 3.5, respectively, where τ₂ is given by Equation 5.3. The u and v parameters, required for executing Equation 3.5, are calculated by Equations 3.2, using a hinge displacement, h, calculated by Equation 4.3 or 4.4. (Notice that the maximum radius is not exactly proportional to the number of teeth because of the constrained step s₂.)

In the closed gear, the alpha tooth is by definition positioned at the spiral angle φ=0, with all the other teeth, at different angles, given by

φ₁ᵢ=(i−k)τ₁; i=1, 2, . . . , zₘₐₓ. (5.4)

Equation 5.4 is calculated for all teeth, even though in the closed state there are only zₘᵢₙ teeth in the gear. However, in this state the extra teeth (from zₘᵢₙ+1 to zₘₐₓ) are still attached to the spiral, with an overlapping of a corresponding portion of the other teeth (from 1 to zₘₐₓ−zₘᵢₙ).

In the open gear the alpha tooth slides to φ=φₘₐₓ. In this state, the spiral angles of all teeth are calculated by

φ₂ᵢ=φₘₐₓ+(i−k)τ₂; i=1, 2, . . . , zₘₐₓ. (5.5)

Now, for given (or guessed) values of the parameters r₀ and b the spiral radii of the closed and the open gears can be calculated by using Equation 2.4:

r₁ᵢ=r₀e^{bφ}^{₁ᵢ} closed gear, (5.6)

r₂ᵢ=r₀e^{bφ}^{₂ᵢ} open gear. (5.7)

In the closed gear all teeth can be positioned on an exactly equal pitch radius by using appropriate bracket offsets which correspond to such condition:

lₜ=Rₘᵢₙ−r₁ᵢ, (5.8)

where Rₘᵢₙ is the given minimum pitch radius.

The bracket offsets, calculated by Equation 5.8, remain constant at all turning angles of the disc, implying a certain maximum pitch radius of the individual teeth in the open gear:

R₂ᵢ=r₂ᵢ+lᵢ. (5.9)

Since the entire calculation is not completely accurate, the resulting maximum pitch radii, given by Equation 5.9, will not exactly match the requirement of the maximum pitch radius, Rₘₐₓ, given by Equation 3.6. The following residuals will be created:

ΔRᵢ=R₂ᵢ−Rₘₐₓ. (5.10)

The problem is now to find a best combination of the parameters r₀ and b which would minimize, as much as possible, the ΔRᵢ residuals. For the convenience of such minimization, Equation 5.10 is written in a more explicit form by a substitution of Equations 5.6 through 5.9 there:

ΔRᵢ=r₀(e^{bφ}^{₂ᵢ}−e^{bφ}^{₁ᵢ})−(Rₘₐₓ−Rₘᵢₙ), (5.11)

where φ₁ᵢ and φ₂ᵢ are the spiral angles in the closed and in the open gear, given by Equations 5.4 and 5.5.

Assume now that we wish to enforce a certain ΔRᵢ to zero by varying the system parameters, r₀ and b, by a small amount, Δr₀ and Δb. Since the variations involved are small numbers, the zeroing condition can be reduced to the following linear approximation:

$$\frac{\partial Δ {R}_{i}}{\partial {r}_{0}} Δ {r}_{0} + \frac{\partial Δ {R}_{i}}{\partial b} Δ b = Δ {R}_{i} . \qquad ( 5.12 )$$

The derivatives used in Equation 5.12 are directly obtained from Equation 5.11:

$$\begin{matrix}\frac{\partial Δ {R}_{i}}{\partial {r}_{0}} = {e}^{b {ϕ}_{2 i}} - {e}^{b {ϕ}_{1 i}} , & ( 5.13 ) \\ \frac{\partial Δ {R}_{i}}{\partial b} = {r}_{0} ( {ϕ}_{2 i} {e}^{b {ϕ}_{2 i}} - {ϕ}_{1 i} {e}^{b {ϕ}_{1 i}} ) . & ( 5.14 )\end{matrix}$$

In reality, we have not just one equation of the type 5.12, but a list of such equations, in accordance with the list of ΔRᵢ residuals. This system of equations can conveniently be written in the following matrix form:

TΔV=ΔR. (5.15)

The variables contained in Equation 5.15 are arrays, defined as follows.

T is an n×2 “transformation matrix,” constructed of the derivatives given by Equations 5.13 and 5.14:

$$T = ( \begin{matrix}\frac{\partial Δ {R}_{1}}{\partial {r}_{0}} & \frac{\partial Δ {R}_{1}}{\partial b} \\ ⋮ & ⋮ \\ \frac{\partial Δ {R}_{n}}{\partial {r}_{0}} & \frac{\partial Δ {R}_{n}}{\partial b}\end{matrix} ) , \qquad ( 5.16 )$$

ΔV is a correction vector of the optimization parameters:

$$Δ V = ( \begin{matrix}Δ {r}_{0} \\ Δ b\end{matrix} ) , \qquad ( 5.17 )$$

and ΔR is a vector of residuals:

$$Δ R = ( \begin{matrix}Δ {R}_{1} \\ \begin{matrix}⋮ \\ Δ {R}_{n}\end{matrix}\end{matrix} ) . \qquad ( 5.18 )$$

The size of the system, n, can in principle be equal to the maximum number of teeth, zₘₐₓ, or be some smaller number, as will be explained later.

Equation 5.15 is an over-determined system of equations because it has more constraints (number of residuals) than unknowns (the corrections Δr₀ and Δb). Such system cannot in principle be solved completely, but it can be optimized by a minimization of the Root-Mean-Square (RMS) of the residuals:

$$S = \sqrt{\frac{1}{2} {\sum }_{i = 1}^{n} Δ {R}_{i}^{2}} , \qquad ( 5.19 )$$

where ΔRᵢ is given by Equation 5.10 or 5.11.

The method of minimization (called the Least-Square or LS method) has a well known solution, according to its original definition by Newton and Gauss:

ΔV=(T^{T}T)⁻¹T^{T}ΔR. (5.20)

In linear problems, a single execution of Equation 5.20 provides the final result of the LS solution. In nonlinear problems, such as the present spiral design, a single calculation of Equation 5.20 is not sufficient, and an iterative process becomes necessary. By this procedure, after every calculation of Equation 5.20 the system parameters are corrected by

r₀=r₀−Δr₀. (5.21)

b=b−Δb, (5.22)

where Δr₀ and Δb are the first and the second terms, respectively, of the correction vector computed by Equation 5.20 (see Equation 5.17).

Following the parameters' correction, the arrays T and ΔR are reconstructed (by recomputing all relevant parts from Equations 5.6 through 5.18), after which Equations 5.20 through 5.22 are executed again. The iterations continue until the RMS change (Equation 5.19) becomes small enough.

The bracket offsets, calculated by Equation 5.8, guarantee an accurate pitch radius in the closed gear, which matches all teeth, while in the open gear some radial residuals, ΔRᵢ, still remain. These residuals, however, can be halved by means of decreasing all offsets, lᵢ, by one half of ΔRᵢ. The decreased offsets are computed by

lᵢ=li−ΔRᵢ/2, (5.23)

where on the right hand side of Equation 5.23, lᵢ is taken from the latest calculation of Equation 5.8. By this way, all the original residuals will be evenly divided between the closed and the open gears, at only one half of their original values.

The resulting offsets, lᵢ, are defined here as the distance between the spiral (at the center of the groove on the disc) and the pitch radius. However, in case the point of attachment of the bracket to the tooth is not exactly at the pitch radius, an appropriate correction of the bracket offset must be made.

We shall now define the desired size of the equation system, given by n in Equations 5.16 and 5.18. As illustrated by a numeric example below, the radial residuals, which result from the LS solution, display a parabolic function of the angular position, where the greatest residuals (in their absolute values) are at the two ends and in the middle of the teeth range. If we are interested in a minimax solution (which makes the maximum residual as small as possible), we should give in the process of the LS solution a maximal weight to those extreme points, and ignore all the other teeth. In order to make the solution symmetric, only four teeth have to be considered for the equation system, namely the first, the last, and two teeth in the middle. For example, if the number of teeth (zₘₐₓ) is 48, the teeth selected for the optimization have to be

i=1, 24, 25, and 48, (5.24)

which makes n=4, and retains only four rows in Equations 5.16 and 5.18.

The results shown in the next chapter confirm that such selection actually provides the desired minimax solution.

Another comment concerning a possible improvement of the LS calculation is given. As mentioned before, Equation 2.4 is a nonlinear function of b, which implies that the LS solution must be made with the aid of iterations, simultaneously for the two system parameters, r₀ and b. However, the r₀ parameter appears in Equation 2.4 in a linear form, which means that it can in principle be extracted from the calculations by expressing it as a function of the other parameter, which is b. By such procedure the LS solution can be reduced to a form of a single unknown, which requires a single solution of a nonlinear function of φ, and also rids us of the matrix arithmetic. Such improvement, however, requires a more complicated mathematical preparation, which could be done in a case of a necessity to reduce the computational load of the calculations.

### NUMERICAL EXAMPLE

For the numeric example shown below the following input data has been used:

m=5 mm Module

zₘᵢₙ=36 Minimum number of teeth

zₘₐₓ=48 Maximum number of teeth

k=13 Sequential number of the alpha tooth

φₘₐₓ=500 deg Maximum turning angle

According to Equations 4.1 through 4.3, the following geometric parameters have been computed:

Rₘᵢₙ==90 mm Minimum pitch radius

τ₁=10 deg Pitch angle in closed gear

τ₂=7.5 deg Pitch angle in open gear

In this example, the side-hinge link is determined by the minimum number of teeth, which is 36. Its characteristic dimensions, according to Equations 3.2, become

u=7.8390 mm, v=0.3994 mm

with the optimal hinge displacement, h (Equation 4.4),

h=0.0571 mm.

Initial values of the estimated parameters, according to equations 2.5 and 2.6, are in this case

R₀=Rₘᵢₙ=90 mm,

b=5.743×10⁻⁴ l/deg.

Next, the angular values of all teeth in the two extreme states of the gear, φ₁ᵢ and φ₂ᵢ, are computed only once by using Equations 5.4 and 5.5. After that, the execution of Equations 5.6 through 5.22 is repeated until the change of RMS (Equation 5.19) becomes smaller than 0.01 mm. In this case, four iterations were required for convergence. The resulting optimization parameters were the following:

r₀=83.68 mm,

b=6.137×10⁻⁴ l/deg.

After convergence, a halving of the radial residuals was made by applying Equation 5.23.

The teeth numbers, selected for the residual minimization, were those given by Equation 5.24.

The residuals for three different rotation angles of the disc were calculated: no rotation (closed gear), full rotation (500 deg, open gear), and an intermediate rotation (250 deg). The maximum calculated residuals were 0.06 mm, and they appear in the extreme rotation states—no turn or maximum turn. At the intermediate rotation the maximum residual is one order of magnitude smaller than at the extreme states. These values are well within the manufacturing tolerances which are considered acceptable for implementation of a gear wheel.

The use of the hinge displacement, h, introduced for keeping the circular pitch nearly constant (see above), makes a change of about 0.1 mm in the spiral radius, but it does not have any detectable effect on the radial residuals.

In this example, the radius varies between 77.7 and 133.6 mm.

It will be appreciated that the above descriptions are intended only to serve as examples, and that many other embodiments are possible within the scope of the present invention as defined in the appended claims.

What is claimed is:

1. A variable diameter gear device for use in a variable ratio transmission system, the variable diameter gear device comprising:
(a) an axle defining an axis of rotation;
(b) a displaceable gear tooth sequence comprising a plurality of interconnected gear teeth lying on a virtual cylinder coaxial with said axle, said gear teeth being spaced at a uniform pitch;
(c) a torque linkage mechanically linked to said axle and to said gear tooth sequence so as to transfer a turning moment between said axle and said gear tooth sequence; and
(d) a diameter changer including at least one disc having a spiral track, and wherein each of said gear teeth is mechanically linked to said spiral track such that rotation of said at least one disc relative to said axle causes variation of an effective diameter of said virtual cylinder while maintaining said virtual cylinder centered on said axis of rotation and while said uniform pitch remains constant.

2. The device of claim 1, wherein said diameter changer includes a pair of said discs deployed on opposite sides of said gear tooth sequence, and wherein each of said gear teeth is mechanically linked to said spiral track of both of said pair of discs.

3. The device of claim 1, wherein said spiral track is implemented as a spiral slot, and wherein a projection is associated with each of said gear teeth, said projection engaging said spiral slot.

4. The device of claim 1, wherein said spiral track is shaped substantially as a logarithmic spiral.

5. The device of claim 1, wherein said gear tooth sequence extends around at least half of the periphery of said effective cylindrical gear.

6. The device of claim 1, wherein said displaceable gear tooth sequence is a first displaceable gear tooth sequence forming part of a gear tooth set further comprising a second displaceable gear tooth sequence having a plurality of gear teeth lying on said virtual cylinder and spaced at said uniform pitch, said diameter changer being configured to displace said gear tooth set so as to vary a degree of peripheral coextension between at least said first and said second gear tooth sequences, thereby transforming the gear device between:
(a) a first state in which said gear tooth set is deployed to provide an effective cylindrical gear with a first effective number of teeth, and
(b) a second state in which said gear tooth set is deployed to provide an effective cylindrical gear with a second effective number of teeth greater than said first effective number of teeth.

7. The device of claim 1, wherein said diameter changer further comprises an adjustment mechanism comprising a planetary gear assembly having a first input driven by rotation of said axle, an output driving rotation of said at least one disc, and a diameter adjustment input, wherein said planetary gear assembly is configured such that, when said adjustment input is maintained static, said at least one disc is driven to rotate in constant angular alignment with said axle, and when said adjustment input is rotated, said at least one disc undergoes a corresponding rotation relative to said axle.
